(19) United States
(12) Patent Application Publication
(10) Pub. No.: US 2015/0135880 A1
(43) Pub. Date: May 21, 2015

(54) SEALED ROBOT BASE SYSTEM

(71) Applicant: Moog Inc., East Aurora, NY (US)

(72) Inventors: Petr Zaruba, Hercules, CA (US); Michael R. Biche, Union City, CA (US); Gerald M. Academia, Hercules, CA (US)

(21) Appl. No.: 14/384,362

(22) PCT Filed: Mar. 15, 2012
(86) PCT No.: PCT/US2012/029284

§ 371 Date: Feb. 6, 2015

(51) Int. Cl. B25J 19/00; B25J 9/04

(52) U.S. Cl. CPC B25J 19/0075; B25J 9/042
USPC 74/490.01

(57) ABSTRACT

A robot comprising a base forming an inner chamber and having an opening, a first link supported by the base and arranged for translational movement generally along a first axis relative to the base, a second link supported by the first link and arranged for rotary motion relative to the first link about a second axis generally parallel to the first axis, the second link extending from the inner chamber through the opening into an outer region, a third link supported by the second link and arranged for rotary motion relative to the second link about a third axis generally parallel to the first axis, a first actuator arranged to control the translational movement of the first link relative to the base, a second actuator arranged to control the rotary motion of the second link relative to the first link, a third actuator supported by the second link and arranged to control the rotary motion of the third link relative to the second link, and a seal between the inner chamber and the outer region arranged to isolate the inner chamber from the outer region.

### TECHNICAL FIELD

The present invention relates generally to the field of robots, and more specifically to a robot base for semiconductor wafer handling.

### BACKGROUND ART

Wafer handling robots are generally known. These systems typically contain multiple operational degrees of freedom to provide translational motion in the z-axis, rotational motion about a theta angle and a variable end effector radius, and are also known as R-theta-z robots.

### BRIEF SUMMARY OF THE INVENTION

With parenthetical reference to the corresponding parts, portions or surfaces of the disclosed embodiment, merely for the purposes of illustration and not by way of limitation, the present invention provides a robot comprising a base forming an inner chamber (134) and having an opening (133), a first link (139) supported by the base (131) and configured and arranged for translational movement (171) generally along a first axis relative to the base, a second link (143) supported by the first link and configured and arranged for rotary motion (172) relative to the first link about a second axis (101) generally parallel to the first axis, the second link (143) extending from the inner chamber (134) through the opening (133) into an outer region (A), a third link (155) supported by the second link (143) and configured and arranged for rotary motion (173) relative to the second link (143) about a third axis (101) generally parallel to the first axis, a first actuator (135) configured and arranged to control the translational movement of the first link relative to the base, a second actuator (145) configured and arranged to control the rotary motion (172) of the second link relative to the first link, a third actuator (157) supported by the second link (143) and configured and arranged to control the rotary motion (173) of the third link (155) relative to the second link, and a seal between the inner chamber (134) and the outer region (A) configured and arranged to isolate the inner chamber (134) from the outer region (A).

The base may be configured and arranged to be mounted to a wall (161) defining a portion of a boundary between the outer region (A) and an inner region (B), and the seal may be configured and arranged to maintain a pressure differential between the outer region (A) and the inner region (B). The inner chamber (134) may be in fluid communication with the inner region (B) and the inner chamber (134) and the inner region (B) may be at generally equal pressures. The seal may comprise a first seal element (163) between the second link (143) and the third link (155). The seal may comprise a second seal element (165) between the second link (143) and the first link (139). The seal may comprise a bellows (167) between the base (131) and the first link (139). The seal may comprise a magnetic fluid seal (163, 165). The translational movement (171) of the first link (139) may be within the inner chamber. The first axis and the second axis may be the same. The second axis and the third axis may be the same. The robot may further comprise a fourth actuator (286) mounted to the second link (243). The third actuator (157) may be supported within a tubular portion of the second link (143). The first link (139) may comprise a generally tubular portion and the second link (143) may extend through the tubular portion. The robot may further comprise a harmonic drive gearbox (151, 159) coupled to one of the actuators (135, 145, 157). The robot may further comprise a linear spindle (137) configured and arranged between the base (131) and the first link (139). The pressure within the outer region (A) may be less than about one atmosphere. The pressure within the inner chamber (134) may be about one atmosphere. The robot may further comprise a robot arm (120) coupled to the second link (143) and the third link (155). The robot may further comprise an end effector output connection (125). The end effector output connection may be configured and arranged to hold an end effector in a radially outwards orientation relative to the first axis.

### BRIEF DESCRIPTION OF THE DRAWINGS

FIG. 1 is a partial sectional view of a first embodiment sealed robot base system.

FIG. 2 is a partial sectional view of the robot base system shown in FIG. 1 supported by a surface.

FIG. 3 is a partial sectional view of the robot base system shown in FIG. 1 coupled to a robotic arm.

FIG. 4 is a partial sectional view of a second embodiment sealed robot base system.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

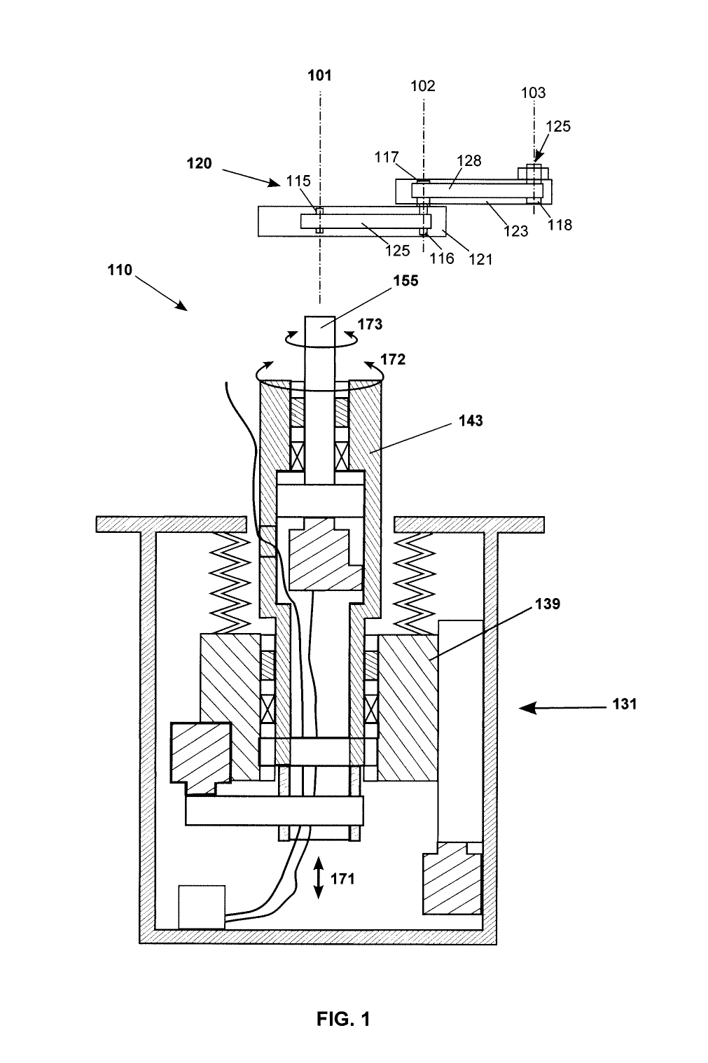

Referring now to the drawings, and more particularly to FIG. 1, an improved R-theta-Z robot base system is provided, a first embodiment of which is shown at 110. Robot base system 110 acts as a base to which a robotic arm 120 is attached. System 110 has improved stiffness and is capable of maintaining a vacuum seal.

As shown, robot base system 110 broadly includes physically grounded body 131, bracket 139, hollow cylinder 143, and drive shaft 155. Bracket 139 is configured for vertical movement 171 relative to grounded body 131. Hollow cylinder 143 is configured for rotation 172 relative to bracket 139 about axis 101. Drive shaft 155 is configured for rotation 173 relative to cylinder 143 about axis 101.

Robot arm 120 includes first link 121, second link 123, and end effector mounting point 125. When attaching robot arm 120 to base system 110, first link 121 is mounted to cylinder 143 such that rotation of cylinder 143 about axis 101 causes rotation of link 121 about axis 101.

Second link 123 is pivotally connected to first link 121 for rotation about axis 102. Drive shaft 155 is operationally coupled to second link 123 through pulley 115, drive belt 127 and pulley 116 such that rotation of drive shaft 155 relative to cylinder 143 about axis 101 causes rotation of second link 123 relative to first link 121 about axis 102. More specifically, pulley 115 is rigidly connected to drive shaft 155 and pulley 116 is rigidly connected to second link 123.

End effector attachment point 125 includes output shaft 118. Output shaft 118 is operationally coupled to first link 121 through drive belt 128, such that rotation of second link 123 relative to first link 121 about axis 102 causes rotation of end effector output shaft 118 relative to second link 123 about axis 103. More specifically, pulley 117 is rigidly connected to first link 121 and output shaft 118 is configured to be rigidly connected to an end effector.

Vertical movement 171 of bracket 139 causes attached robot arm 120 to be moved vertically as well. In summary, the up and down movement 171 and rotations 172, 173 of robot base 110, causes up and down movement and rotations in robot arm 120, such that end effector attachment point 125 can be moved throughout a three dimensional space.

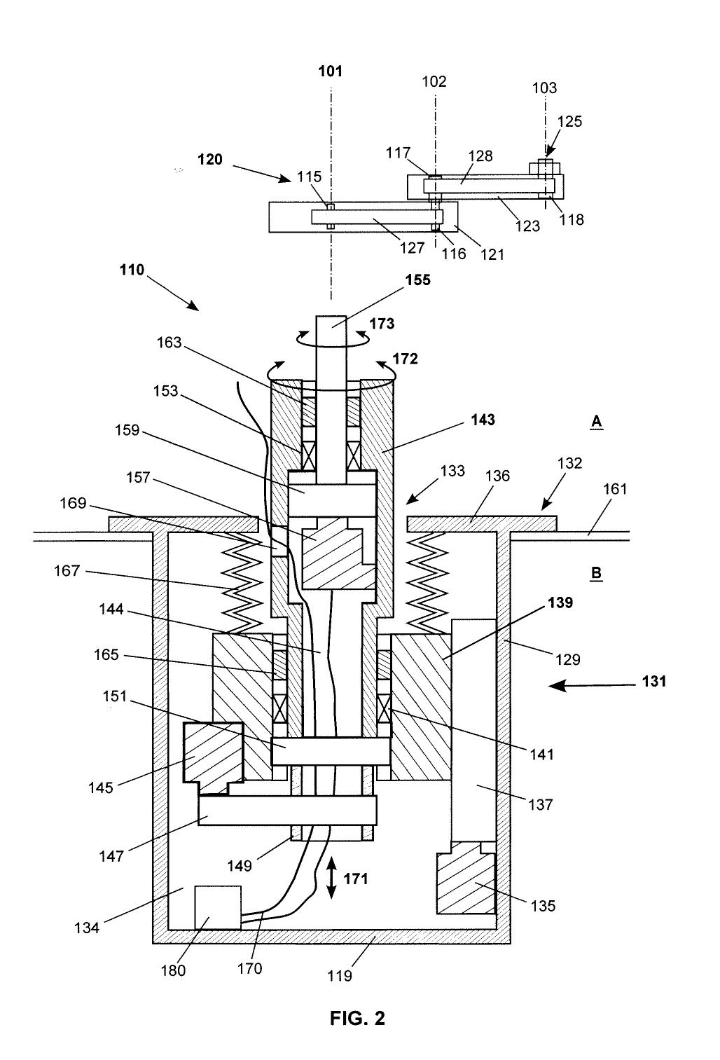

FIG. 2 shows robot base system 110 mounted to vacuum chamber wall 161 in a vacuum environment. The environment A above wall 161 is vacuumized, whereas the environment B below wall 161 is at atmospheric pressure. Thus, in this embodiment wall 161 provides a medium and pressure differential between vacuumized pressure and atmospheric pressure. However, other pressure differentials can may be maintained.

Body 131 is a vertically oriented generally hollow cylinder member defining inner chamber 134. Body 131 is formed by vertical cylindrical portion 129 orientated about axis 101, horizontal closed bottom circular portion 119, horizontal top annular end portion 136, and horizontal annular flange extension 132. In this embodiment, body 131 is aluminum. However, titanium, steel, high strength plastic, composites, or other similar high modulus of elasticity materials, for example, may be used.

As shown, annular flange portion 132 extends radially outwardly from the top edge of cylindrical portion 129. Annular top end portion 136 extends radially inwardly from the top edge of cylindrical portion 129 and has a centrally located circular opening 133. Flange lip portion 132 is tightly coupled to wall 161 to form an air-tight seal across the body-to-wall interface. Wall 161 provides adequate structural support to rigidly immobilize robot base system 110.

Z motor 135 is mounted to the inner cylindrical surface of cylindrical portion 129 of base 131. Alternatively, z motor 135 may be mounted to the housing of linear spindle 137. In this embodiment, z motor 135 is a three phase DC brushless permanent magnet rotary servo motor with an internal absolute encoder. However, other similar actuators may be used, including for example stepper motors, hydraulic actuators, gear reduction and belt drives. Z motor 135 is oriented such that its output shaft axis is vertical or parallel to axis 101. The output of z motor 135 connects to linear spindle 137. In this embodiment, linear spindle 137 is a low backlash ball screw based linear spindle. However, other similar linear spindles may be used. Also, instead of a rotary z motor coupled to a linear spindle, a linear actuator may be used.

Linear spindle 137 is mounted to the inner cylindrical surface of cylindrical portion 129 or base 131. Linear spindle 137 includes a translating linear slide portion that is connected to bracket 139. Bracket 139 is configured and arranged for vertical sliding movement 171 relative to body 131. Actuation of z motor 135 causes linear spindle 137 to vertically displace bracket 139 up or down relative to base 131 in a controlled manner.

Bearing 141 is mounted to bracket 139 and holds cylinder 143 in rotational engagement about axis 101 with bracket 139. Cylinder 143 is prevented from sliding upwards or downwards relative to bracket 139. Cylinder 143 is a generally vertically oriented tubular member having internal hollow chamber 144. In this embodiment, cylinder 143 is stainless steel. However, titanium, aluminum, high strength plastic, composites, or other similar high modulus of elasticity materials, for example, may be used.

Cylinder drive motor 145 is also mounted to bracket 139. In this embodiment, cylinder drive motor 145 is a three phase DC brushless permanent magnet rotary servo motor with an internal absolute encoder. However, other similar actuators may be used, including for example stepper motors, hydraulic actuators and/or planetary gear stages. The output shaft of cylinder drive motor 145 is coupled to drive belt 147. Drive belt 147 transfers rotary power from cylinder drive motor 145 to intermediate gear 149. Intermediate gear 149 is configured for rotation about a vertical axis and is mounted to an input shaft of gear box 151. Gearbox 151 is mounted to bracket 139 and has an output rotationally coupled to cylinder 143. Gearbox 151 provides a mechanical advantage between the rotation of intermediate gear 149 relative to bracket 139, and the rotation of cylinder 143 relative to bracket 139. More specifically, in this embodiment, gearbox 151 provides a gear reduction ratio of greater than 1:50 and preferably about 1:100, providing higher angular precision and torque than what is provided by drive motor 145. In this embodiment, gearbox 151 is a hollow, no backlash harmonic drive, such as produced by Harmonic Drive LLC of San Jose, Calif., USA. However, other hollow gearboxes or other gear box types may be used. As cylinder drive motor 145 is actuated, cylinder 143 is caused to rotate 172 about axis 101 relative to body 131.

Bearing 153 is arranged between the inner cylindrical surface of cylinder 143 and the outer cylindrical surface of drive shaft 155. Bearing 153 holds drive shaft 155 in rotational engagement with cylinder 143 for rotation about axis 101, but prevents any translational movement between drive shaft 155 and cylinder 143. In this embodiment, drive shaft 155 is stainless steel. However, titanium, aluminum, high strength plastic, composites, or other similar high modulus of elasticity materials, for example, may be used.

Drive shaft motor 157 is supported by the inner cylindrical surface of cylinder 143. In this embodiment, drive shaft motor 157 is a three phase DC brushless permanent magnet rotary servo motor with an internal absolute encoder. However, other similar actuators may be used, including for example stepper motors, hydraulic actuators and/or planetary gear stages. Gearbox 159 is also mounted to the inner cylindrical surface of cylinder 143. The output of drive shaft motor 157 is connected to the input of gearbox 159. The output of gearbox 159 is coupled to drive shaft 155. Gearbox 159 transfers rotational power and provides a mechanical advantage between drive shaft motor 157 and drive shaft 155. More specifically, in this embodiment gearbox 159 provides a gear reduction of greater than about 1:50 and preferably about 1:100, providing higher angular precision and torque than what is provided by shaft motor 157. In this embodiment, gearbox 159 may also be a no backlash harmonic drive, such as produced by Harmonic Drive LLC of San Jose, Calif., USA. However, other gearboxes may be used. As drive shaft motor 157 is actuated, drive shaft 155 is caused to rotate 173 about axis 101. In this embodiment, rotation 173 of drive shaft 155 relative to cylinder 143 is independent of rotation 172 of cylinder 143 relative to body 131. More specifically, they form two independent degrees of freedom.

As shown in FIG. 2, annular seal 163 is arranged between the inner cylindrical surface of cylinder 143 and the outer cylindrical surface of drive shaft 155. Similarly, annular seal 165 is arranged between the inner cylindrical surface of bracket 139 and the outer cylindrical surface of cylinder 143. In this embodiment, seals 163 and 165 are magnetic fluid seals, such as Ferrofluidic seals from Ferrotec Corporation of Santa Clara, Calif., USA. However, other rotational vacuum seals can also be used. Seal 163 prevents air or other fluid flow between the region above wall 161 and hollow chamber 144 of cylinder 143. Similarly, seal 165 prevents air or other fluid flow between the region above wall 161 and inner chamber 134 of body 131.

Cylindrical bellows 167 is arranged between top portion 136 of body 131 and bracket 139. Bellows 167 comprises a flexible material that allows expansion and contraction as cylinder 143 moves up and down 171 relative to body 131. Bellows 167 provides vacuum isolation between the region A above wall 161 and inner chamber 134 of body 131. Together, bellows 167, seal 163 and seal 165 atmospherically isolate the region A above wall 161 and the region B below wall 161, including chamber body 134.

Pass through 169 is arranged through the side wall of cylinder 143 and provides an air-tight passage for control wires 170 to pass from body chamber 134 to the region A above wall 161. Wires 170 include power, sensor and control lines for robot arm 120 or its end effector, and may include other similar wires. Wire 170 may be connected to controller 180. Controller 180 is mounted to the bottom inner surface of portion 119 of body 131. However, controller 180 may be alternatively mounted externally to base 131 to allow easier access. Controller 180 includes a real-time computer, power supply, motor drivers and communication hardware. Controller 180 receives position sensor input from each of motors 135, 145 and 157, and outputs the motor drive for each of these motors.

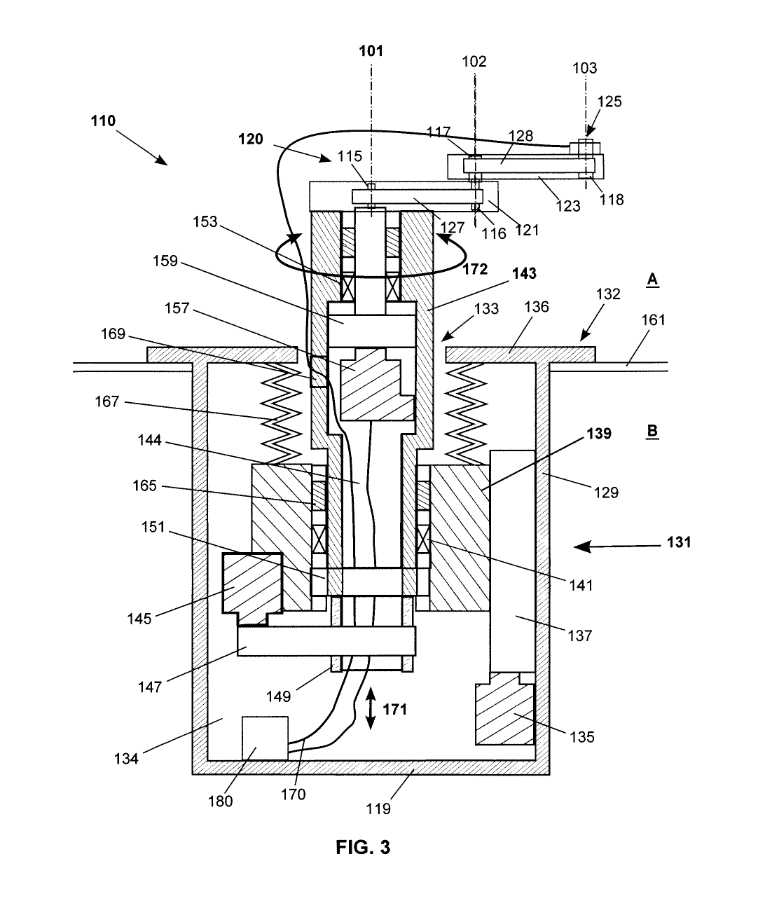

FIG. 3 shows robotic arm 120 coupled to R-theta-z robot base system 110. Robot arm 120 includes end effector attachment point 125. Link 121 of robot arm 120 is rigidly connected to the top of cylinder 143. Drive shaft 155 is rigidly connected to pulley 115. Pulley 115 is rotationally coupled to pulley 116 through drive belt 127. Pulley 116 is rigidly connected to second link 123. Drive belt 127 is configured to transfer rotational power between drive shaft 155 and second link 123 to thereby rotate link 123 about axis 102.

End effector output shaft 118 is operationally coupled to first link 121 and second link 123 such that the orientation of the end effector is preserved in a radially outward orientation as first link 121 and second link 123 rotate relative to each other about axis 102. More specifically, pulley 117 is rigidly connected to first link 121. As first link 121 rotates relative to second link 123 about axis 102, pulley 117 also rotates relative to second link 123 and causes drive belt 128 to rotate output shaft 118. The length of robot arm first link 121 is equal to the length of second link 123. The diameter of pulley 117 is equal to one half the diameter of output shaft 118. This causes the orientation of end effector output shaft 118 to rotate at one half the rate relative to second link 123 as second link 123 rotates relative to first link 121.

By controlling motors 135, 145 and 157, controller 180 is capable of translating the end effector within three dimensions while keeping the end effector oriented radially outwards from axis 101.

The disclosed R-theta-z robot base system and method resulted in several surprising advantages. The disclosed z robot base system is stiffer and stronger than prior art wafer handling robots for vacuum environments. By placing drive shaft drive motor 157 within cylinder 143 instead of mounted within body 131, several advantages are obtained. Because the vertical height of drive shaft 155 is much less than if drive shaft 155 needed to extend to the bottom of base 131, the mechanical deformation experienced by the drive shaft is much less. More specifically, the torsional deformation along axis 101 of drive shaft 155 is proportional to the height of drive shaft 155. This height is reduced by moving drive shaft drive motor 157 from a position along wall 119 of base 131 to a position in cylinder 143. The height is reduced and the angular deformation experienced by drive shaft 155 for a given torsional load is reduced. Also, due to the reduced height of drive shaft 155, the maximum possible z stroke is increased for a given maximum allowable torsional deformation.

The use of harmonic drive gearboxes results in lower backlash in the system, higher torque capability, higher resolution and repeatability. Such gearboxes also fit in a smaller volume than gear systems without harmonic gear drive gearboxes. Also, harmonic gear drives can be obtained that are hollow, which allows a convenient conduit for wires.

The use of magnetic fluid seals provides a system with a vacuum seal that has a longer life and requires less maintenance compared to other types of vacuum seals.

The reduction in deformation by shortening drive shaft 155, combined with the use of harmonic drive gears, and high elastic modulus materials results in increased mechanical stiffness of the overall system. This results in a higher natural resonant frequency of the system. The resulting stiffer system is capable of moving faster and supporting higher loads, as well as resulting in a more stable and easier to control servo mechanism.

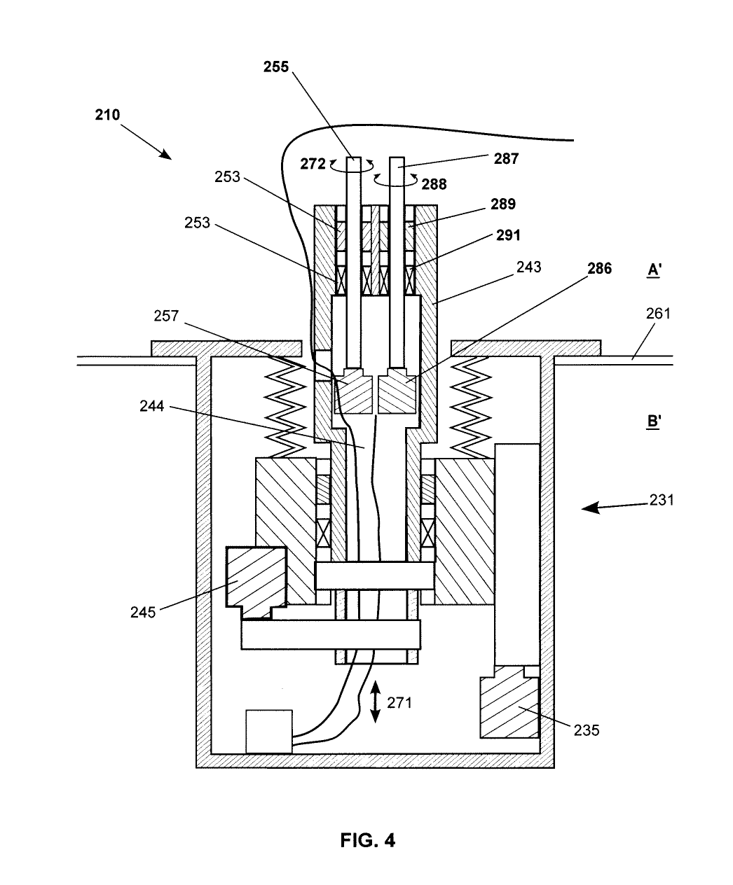

Various alternative embodiments of the disclosed actuator system and method are also possible. For example, FIG. 4 shows second embodiment robot base system 210. System 210 may be used with a robot arm having an end effector which may be independently rotated as desired. Yaw motor 286 is mounted to cylinder 243 for controlling second drive shaft 287. Second drive shaft 287 is operationally coupled to an end effector output shaft such that actuation of yaw motor 286 causes independent rotation of the end effector. Output shaft 255 is coupled to the robot arm similar to the connection of output shaft 155 to robot arm 120 in the first embodiment shown in FIG. 3. Second link 243 couples to a robot arm similar to the connection of second link 143 to robot arm 120 in the first embodiment shown in FIG. 3. Instead of controlling an end effector orientation, motor 286 may be used to control a different degree of freedom in an attached robot arm.

Therefore, while the presently-preferred form of the R-theta-z robot base system has been shown and described, and several modifications discussed, persons skilled in this art will readily appreciate that various additional changes may be made without departing from the scope of the invention.

1. A robot comprising:
a base forming an inner chamber and having an opening;
a first link supported by said base and configured and arranged for translational movement generally along a first axis relative to said base;
a second link supported by said first link and configured and arranged for rotary motion relative to said first link about a second axis generally parallel to said first axis;
said second link extending from said inner chamber through said opening into an outer region;
a third link supported by said second link and configured and arranged for rotary motion relative to said second link about a third axis generally parallel to said first axis;
a first actuator configured and arranged to control said translational movement of said first link relative to said base;
a second actuator configured and arranged to control said rotary motion of said second link relative to said first link;
a third actuator supported by said second link and configured and arranged to control said rotary motion of said third link relative to said second link; and
a seal between said inner chamber and said outer region configured and arranged to isolate said inner chamber from said outer region.

2. The robot set forth in claim 1, wherein said base is configured and arranged to be mounted to a wall defining a portion of a boundary between said outer region and an inner region and said seal is configured and arranged to maintain a pressure differential between said outer region and said inner region.

3. The robot set forth in claim 2, wherein said inner chamber is in fluid communication with said inner region and whereby said inner chamber and said inner region are at generally equal pressures.

4. The robot set forth in claim 1, wherein said seal comprises a first seal element between said second link and said third link.

5. The robot set forth in claim 1, wherein said seal comprises a second seal element between said second link and said first link.

6. The robot set forth in claim 1, wherein said seal comprises a bellows between said base and said first link.

7. The robot set forth in claim 1, wherein said seal comprises a magnetic fluid seal.

8. The robot set forth in claim 1, wherein said translational movement of said first link is within said inner chamber.

9. The robot set forth in claim 1, wherein said first axis and said second axis are the same.

10. The robot set forth in claim 1, wherein said second axis and said third axis are the same.

11. The robot set forth in claim 1, and further comprising a fourth actuator mounted to said second link.

12. The robot set forth in claim 1, wherein said third actuator is supported within a tubular portion of said second link.

13. The robot set forth in claim 1, wherein said first link comprises a generally tubular portion and said second link extends through said tubular portion.

14. The robot set forth in claim 1, and further comprising a harmonic drive gearbox coupled to one of said actuators.

15. The robot set forth in claim 1, and further comprising a linear spindle configured and arranged between said base and said first link.

16. The robot set forth in claim 1, wherein a pressure within said outer region is less than about one atmosphere.

17. The robot set forth in claim 16, wherein a pressure within said inner chamber is about one atmosphere.

18. The robot set forth in claim 1, and further comprising a robot arm coupled to said second link and said third link.

19. The robot set forth in claim 18, and further comprising an end effector output connection.

20. The robot set forth in claim 19, wherein said end effector output connection is configured and arranged to hold an end effector in a radially outwards orientation relative to said first axis.
